(19) United States
(12) Patent Application Publication
(10) Pub. No.: US 2016/0290922 A1
(43) Pub. Date: Oct. 6, 2016

(54) Low Energy Laser Spectroscopy

(71) Applicant: Gustav Hudson, Fallbrook, CA (US)

(72) Inventor: Gustav Hudson, Fallbrook, CA (US)

(21) Appl. No.: 15/181,979

(22) Filed: Jun. 14, 2016

Related U.S. Application Data
(63) Continuation-in-part of application No. 14/559,744, filed on Dec. 3, 2014.

(51) Int. Cl. G01N 21/63; G01J 3/10

(52) U.S. Cl. CPC G01N 21/63; G01J 3/10; G01N 2201/0612; G01N 2201/12

(57) ABSTRACT

In a spectrophotometer and a method of operation, very low levels of energy are produced in a laser diode and directed to excite a sample. Energy is provided to a quantum well to bring the laser diode to a pre-lasing state. Another increment of energy causes the laser diode to emit energy at an energy level lower than a visible laser beam. The energy produced by the laser is collided with the sample. A stimulated emission from the sample includes signals from various entities in the sample. The return emission spectra from the sample comprise signatures used to identify compounds. Use of such very low energies collided with a sample elicit spectra not previously associated with respective analytes. A Raman spectroscopy platform is used for performance of the method.

### CROSS REFERENCE TO RELATED APPLICATIONS

This application is a Continuation-in-Part of application Ser. No. 14/559,744 filed on Dec. 3, 2014, entitled Low Energy Laser Spectroscopy—LELS, which is incorporated herein by reference in its entirety.

### FIELD

The present subject matter relates to spectroscopy employing irradiation of samples by gentle low energy and detecting spectra of returned energies.

### BACKGROUND

In the present specification, a spectrum is defined as an organized and reproducible separation of a series of physical entities, such as wavelengths, photons, masses, momenta, and magnetic spins, into a linear arrangement of components of the entity arranged according to their increasing values. The well-known continuum of colored light, as seen in a rainbow, occurs as white light passes through raindrops, which serve as a diffraction grating or through a transparent prism. The diffraction grating or prism separates the photons in white light into cohorts having the same energy, ranging from around 5×10⁻¹⁹ J at the violet end of the spectrum to 2.6×10⁻¹⁹ J in the red portion of the spectrum. The wavelengths of different colors of the visible light spectrum range from about 4×10⁻⁵ cm for violet to 7×10⁻⁵ cm for red.

A spectrometer is a device which is capable of acting upon a physical entity in such a way as to cause the entity to separate its components into a spectrum. Current spectrometers subject a material to be analyzed to a source of energy capable of inducing properties of the sample which can be separated reproducibly into entities which make up a spectrum. For example, a mass spectrometer functions by applying sufficient energy to break a sample into ions of different atomic or molecular masses and separating the ions formed using a magnetic field to yield a spectrum based on increasing mass. Nuclear Magnetic Resonance (NMR) spectrometers and Electron Spin Resonance (ESR) spectrometers operate by subjecting physical entities to extremely high magnetic fields, then applying a pulse of energy at an angle to the direction of the magnetic field, inducing a precession of either atomic nuclei or electrons, depending on the type of spectrometer used. NMR spectra record the time required for chemical groups within the entity to return to their original state. By manipulation of the timing of pulses of energy applied to the sample, NMR yields information about the chemical groups of a compound, the positions of one group to other groups in the compound and even the three dimensional state of the compound. Other forms of spectroscopy involve measurements of photons released after applying high energy to an entity and measuring either the energy absorbed by the entity or the photons released from the entity as a result of the exposure to high energy. The spectrometers, which may also be called spectrophotometers since they are involved in measurements of photons, can be divided into various types, namely, ultraviolet-visible spectrophotometers, infrared spectrophotometers, Raman spectrophotometers, atomic emission spectrometers and fluorimeters. All the different types of spectrometers discussed above are essential in the process of identifying new chemicals and detection of chemicals, including pharmaceuticals, in samples.

U.S. Pat. No. 9,285,272 discloses a dual source system and method that includes a high power laser used to determine elemental concentrations in a sample and a lower power device used to determine compounds present in the sample. A detector subsystem receives photons from the sample after laser energy from the high power laser strikes the sample and provides a first signal. The detector subsystem then receives photons from the sample after energy from the lower power device strikes the sample and provides a second signal. The high power laser is pulsed and the first signal is processed to determine elemental concentrations present in the sample. The lower power device is energized and the second signal is processed to determine compounds present in the signal. Based on the elemental concentrations and the compounds present, the compounds present in the sample are quantified. Two different power sources are required to generate separate spectra for elements and for compounds.

U.S. Pat. No. 9,278,331 discloses a method and a system for producing a change in a medium. The method places in a vicinity of the medium at least one energy modulation agent. The method applies an initiation energy to the medium. The initiation energy interacts with the energy modulation agent to directly or indirectly produce the change in the medium. The system includes an initiation energy source configured to apply an initiation energy to the medium to activate the energy modulation agent. This energy is not at a low level adjacent a threshold that will induce lasing.

U.S. Pat. No. 9,202,678 discloses an ultrafast laser used with a mass biological mass spectrometry. It also discloses a femtosecond laser beam pulse which is emitted upon an ionized specimen to remove at least one electron therefrom. One embodiment emits at least one shaped laser pulse, having a duration of less than 1 ps and a wavelength greater than 700 nm, at an ionized specimen in a mass spectrometer. Specific strong bonds are selectively fragmented before weak bonds in the specimen. Fragmenting of bonds is required to derive a spectral signature.

U.S. Pat. No. 9,188,538 discloses a Raman microscope and a Raman spectrometric measuring method. The Raman microscope includes a pump light source for emitting pump light as continuous light; a relaxation light source for emitting relaxation light to induce stimulated emission in a sample; a dichroic mirror for irradiating the relaxation light and the pump light to the sample; a spectrograph for spectrally separating Raman scattered light generated in the sample; and a detector for detecting the Raman scattered light spectrally separated in the spectrograph. This arrangement requires two light sources to induce emission in a sample rather than one light source.

U.S. Pat. No. 8,088,628 discloses spectroscopic analysis systems and methods for analyzing samples which exploit inelastically scattering radiation to amplify optical signals from an irradiated sample. Samples are irradiated in a chamber having a resonant cavity containing a plurality of affixed reflectors, where selective Stokes scattered radiation is transmitted to a detector for determination of sample identity. A chamber according to embodiments of the invention contains a resonant cavity to contain a sample for analysis, at least one window to the cavity to transmit a first radiation having a first frequency (e.g., an input excitation radiation from a laser) into the cavity and to transmit a second electromagnetic radiation having a second frequency (e.g., an output beam of stimulated Raman radiation) out of the cavity, and a plurality of reflectors (e.g., multi-layer dielectric mirrors) affixed to a housing of the cavity to reflect radiation of a predetermined frequency (e.g., the stimulated radiation). The apparatus and methods are limited to Stokes radiation.

### SUMMARY

Briefly stated a novel spectrophotometer and a method of operation are provided. Very low levels of energy at a lasing threshold are produced in a laser diode and directed to excite a sample. The energy produced by the laser is collided with the sample. A stimulated emission from the sample includes signals from various entities. The return emission from the sample produces spectra which comprise signatures used to identify compounds. The spectra do not correspond to results produced using the standard types of spectroscopy discussed above. A Raman spectroscopy platform is used for performance of the method. Data obtained are not from Raman nor any other emission or absorption spectroscopy methods.

Energy is provided to the quantum well of a diode laser to bring the laser to a pre-lasing state. Another increment of energy is applied to take the diode to its lasing threshold. This causes the diode laser to emit energy at an energy level lower than standard Raman spectroscopy levels. The particles within the quantum well of the laser, which include omnipresent cosmological dark matter (OCDM) and omnipresent cosmological dark energy (OCDE) become quantum entangled with photons and any other particles existing in the quantum well of the laser creating a wave package. The low energy laser emission collides with the OCDM and OCDE also present in the sample. The photons in entanglement scatter off upon encountering a solid, and a quantum tunnel not subject to time is created. The emission and remission of the particles exist in same-time. The return emission from the sample produces spectra which comprise signatures used to identify elements and compounds and their spectral signature. During the protocol, the fragile quantum state is maintained and, critically, entanglement is preserved, which is key for quantum computing.

A key requirement for any information technology, is the ability to relocate data between locations. Possibilities open up in the long-distance transmission of qubit information, which could be used to create quantum cryptography, quantum cloud computing, quantum teleportation. Because of the ability to quantify the amount of OCDM-OCDE present in each individual element a new periodic table based on the measurement of amount of OCDM-OCDE present in each atom of each element is now possible.

New elements and compounds may be discovered using the quantification of OCDM-OCDE in each element.

The use of such very low energies to elicit a spectrum has given rise to observations which cannot be explained using our current knowledge of photon behavior. The observed spectra are believed to be due to excitation and detection of quantum entangled OCDE or OCDM or a combination of the two, in the sample. The present subject matter is able to resolve the presence of low amounts of analytes in a sample. Spectral signatures of samples identify specific metals such as gold and silver in solid materials, including metal blocks and large crystals. The present subject matter is able to obtain a spectrum from a pharmaceutical sample encased in blister pack packaging as the quantum entangled OCDM, OCDE create a quantum tunnel not subject to time, the blister pack does not exist in the same time-space, allowing the collision with the encased sample to occur. There is an increase in energy count returning through a solid object which is atypical of all other Raman spectroscopy and may be caused by energy-time entangled particles of OCDM-OCDE. The extremely low energy required to induce a spectrum from a sample is suitable for probing living tissue without damaging it.

### DRAWINGS

FIG. 1 is a block diagram of a low energy laser spectroscopy system constructed in accordance with the present subject matter;

FIG. 2 illustrates accumulation of spectrographic data;

FIG. 3 illustrates the timing and generation of gate pulses for a photomultiplier;

FIG. 4 is a waveform chart illustrating relative timing of a trigger pulse and a gate pulse;

FIG. 5 is a diagram of one form of quantum well laser diode suitable for use in the laser in the present platform;

FIG. 6 illustrates a further form of laser diode comprising a separate confinement laser quantum well;

FIG. 7 is a cross-sectional illustration of the Raman probe which both excites and collects energy from a sample;

FIG. 8 is a cross-sectional illustration of a single long length fiber optic strand (LLFO) transmitting and receiving energy within the present system;

FIG. 9 is a cross-sectional illustration of a mechanical coupling for stabilizing the long length fiber optic strand;

FIG. 10 is a cross-sectional illustration of the mechanical coupling of an end of the LLFO into the convergence field of the Raman probe;

FIG. 11 is a cross-sectional illustration of the single fiber optic strand of FIG. 8 inserted into a medical syringe;

FIG. 12 is a cross-sectional illustration of a biopsy needle having the LLFO pre-inserted and being affixed to the syringe;

FIG. 13 is a cross-sectional illustration in which the Raman probe is located in the syringe to comprise a bioprobe;

FIG. 14 is a plot of spectral data obtained by a first form of Raman probe from an irradiated sample of a carbon fluorine perfluorodecalin chemical composition;

FIG. 15 is a plot of spectral data obtained by a second form of Raman probe from the irradiated sample of a carbon fluorine perfluorodecalin chemical composition;

FIG. 16 is a printout of a nominal LELS system run and spectroscopic analysis producing spectra of the type seen in FIG. 14 and FIG. 15;

FIG. 17 comprises a spectrum plot of Bayer® aspirin, C9H8O4;

FIG. 18 comprises a spectrum of Zyrtec® cetirizine;

FIG. 19 is a spectrum generated from a static sample of a carbon fluorine bond perfluorodecalin chemical composition;

FIG. 20 illustrates spectra of carbon fluorine bond hexane chemical composition C6F14;

FIG. 21 represents spectra of a carbon fluorine bond perfluorodecalin Cl0F18;

FIG. 22 represents actual spectra of energies collected from a sample of Tylenol® acetaminophen, C8H9N02;

FIG. 23 represents spectra generated from Lipitor® atorvastatin;

FIG. 24 illustrates spectra for three different forms of aspirin tablets;

FIG. 25 illustrates comparison of a spectrum generated from Lipitor® atorvastatin tablet and a spectrum generated from a generic atorvastatin tablet;

FIG. 26 represents a real time rapid assay and spectral results of pharmaceutical identification of Tylenol® acetaminophen, C8H9NO2;

FIG. 27 represents a spectrum generated from Cipro® ciprofloxacin hydrochloride;

FIG. 28 represents a spectrum generated from a solid tablet of Motrin® ibuprofen;

FIG. 29 represents a spectrum generated from amethyst crystal with natural dark purple coloring;

FIG. 30 represents a spectrum generated from quartz, a form of SiO2;

FIG. 31 represents spectra generated from tourmaline crystal;

FIG. 32 represents a spectrum generated from an almandine garnet crystal, Fe3Al2(SiO4)3;

FIG. 33 represents a spectrum generated from clear morganite crystal, Be3Al2(SiO3)6;

FIG. 34 represents a spectrum generated from clear crystal topaz, (Al2SiO4(F,OH)2);

FIG. 35 represents a spectrum generated from 0.925 sterling silver;

FIG. 36 represents a spectrum generated from silver sulfate ointment;

FIG. 37 represents a spectrum generated from 14 karat gold; and

FIG. 38 represents a spectrum generated from a typical rough ore sample from a tourmaline mine.

### DESCRIPTION

The present subject matter utilizes low level of expectation of samples to induce samples 1 to emit spectra previously unknown. The process is performed on a platform 10 such as a Raman spectroscopy platform. However, the process is not Raman spectroscopy.

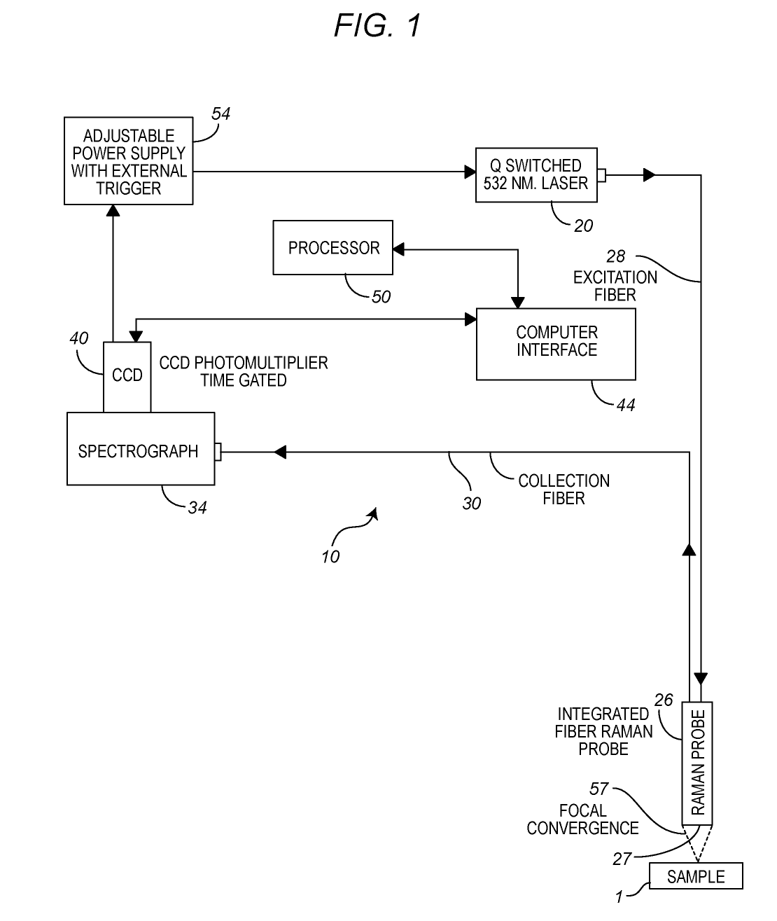

FIG. 1 is a block diagram of a low energy laser spectroscopy system constructed in accordance with the present subject matter. The platform 10 includes hardware to perform the system functions. Interfaces and processors are shown as being included in the platform 10. However, they may be located remotely. In the illustrated embodiment, a laser 20 provides excitation energy to a Raman probe 26 via a fiber optic cable 28. Energy is focused on the sample 1 by a lens 27. A sample holder 2 may be provided to facilitate handling of the sample 1. Excitation of the sample 1 causes the sample 1 to generate an emission. The emission is returned to the Raman probe 26 and transmitted by a fiber optic cable 30 to a spectrograph 34. The spectrograph 34 and a photomultiplier 40 together operate as a spectrophotometer. The spectrometers, which may also be called spectrophotometers since they are involved in measurements of photons, can be divided into various types, namely, ultraviolet-visible spectrophotometers, infrared spectrophotometers, Raman spectrophotometers, atomic emission spectrometers and fluorimeters. The spectrograph 34 forms a spectrum from the energy received. This spectrum is detected by the photomultiplier 40. The photomultiplier 40 comprises a charge coupled device (CCD) time-gated photomultiplier 40. The photomultiplier 40 outputs are coupled by a computer interface 44 to a processor 50. The processer 50 may provide data to a display 56 which can interact with a graphical user interface (GUI) 58.

The photomultiplier 40 is also coupled to an adjustable external power supply 54 with an external trigger, hereinafter the power supply 54. The power supply 54 is coupled to energize the laser 20 as further described below. Triggering is timed to coordinate excitation of the laser 20, initiation of time windows in which the photomultiplier 40 is be responsive to the spectrograph 34, and initiation of time windows in which received energy will accumulate. For convenience in description, emissions to and from the sample 1 are referred to as energy. Using this terminology, energy may include particles, waves, or combinations of particles and waves, omnipresent cosmological dark matter (OCDM), omnipresent cosmological dark energy (OCDE), or combinations of the same.

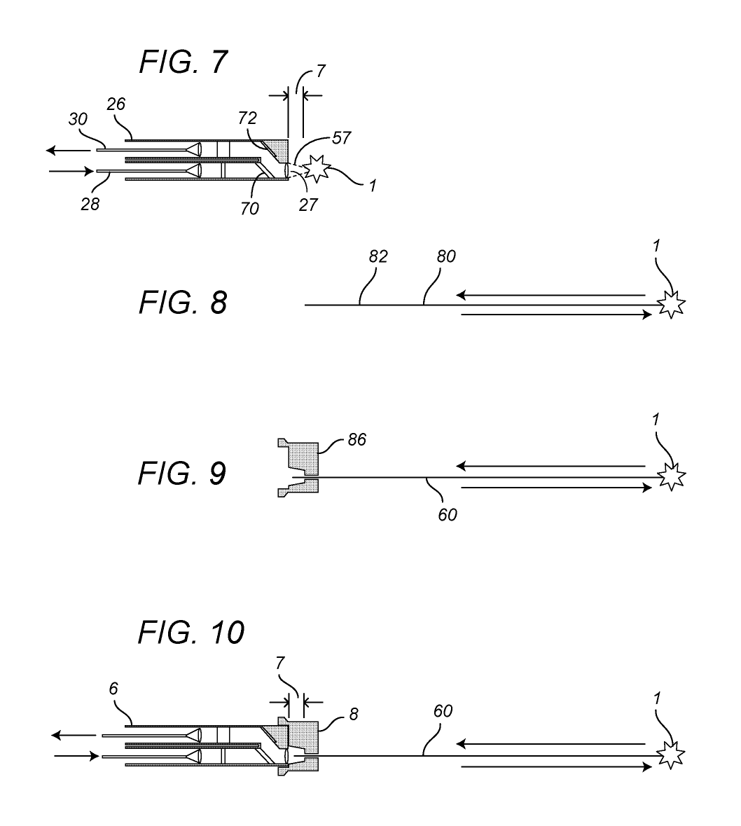

In the illustrated embodiment, the laser 20 comprises a YAG Q-switched diode pump laser producing 532 nm green radiation. For the analytes discussed below, 532 nm is a preferred wavelength for excitation. Other wavelengths could be used. Q-switched diode pumped lasers other that YAG lasers may also yield similar spectra. Radiation from the laser 20 is conducted to the sample 1. The sample 1 is preferably enclosed in a light excluding chamber or may simply be placed in a dark room. The fiber optic cable 28 preferably comprises an RF shielded, internally connected, coated fiber optic cable. A suitable diameter for the fiber optic cable 28 is 100 microns (100μ). The fiber optic cable 28 is terminated at the Raman probe 26. manufactured for passage of 532 nm radiation using a bandpass filter and a dichroic filter (FIG. 7). The Raman probe 26 has a standard focal lens 27 with 5 mm convergence. The energy passed through the Raman probe 26 irradiates the sample 1.

Returned energy from the sample 1 passes back through the focal lens 27, and is reflected off the dichroic filter to the mirror and a long pass filter assembly (FIG. 7) and is focused on the second fiber optic cable 30. The second fiber optic cable 30 is an RF shielded coated fiber optical cable preferably having a diameter of 200μ. The second fiber optic cable 30 provides energy to the spectrograph 34. One suitable spectrograph is the SR3031 gtg 12001/mm 500 nm blaze spectrograph from And or Technology Ltd. of Belfast, UK. The spectrum formed by the spectrograph 34 is detected by the photomultiplier 40. A suitable photomultiplier 40 comprises a specially programmed CCD photomultiplier such as a 2048×512, 13.5 μm, 2 ns, 18 mm, G2W, P43 photomultiplier, also from And or Technology. The special programming is provided by Solis® (s) Software by And or Technology for spectroscopy for standard Raman spectroscopy. The present subject matter utilizes particular settings for the camera used to collect the spectra.

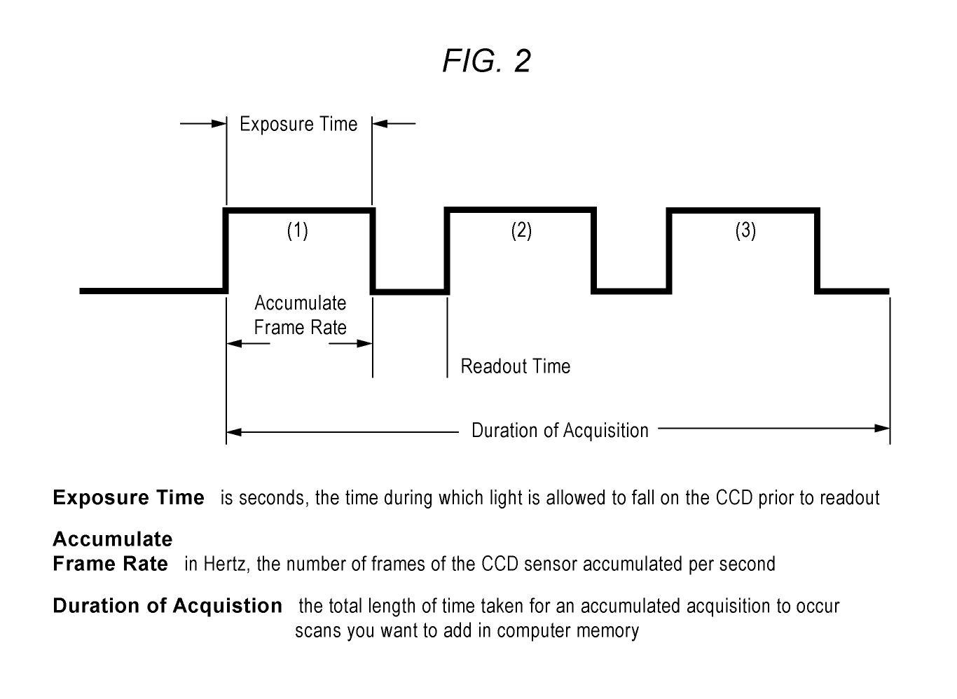

In accordance with the present subject matter, energy emission from the laser 20 is achieved in two steps. Operations are coordinated by the Solis® (s) Software via the CCD 40. The spectrograph 34 will be enabled to receive signals for respective pulses of laser excitation energy. Pulses and timing are further illustrated with respect to FIGS. 2-4 below.

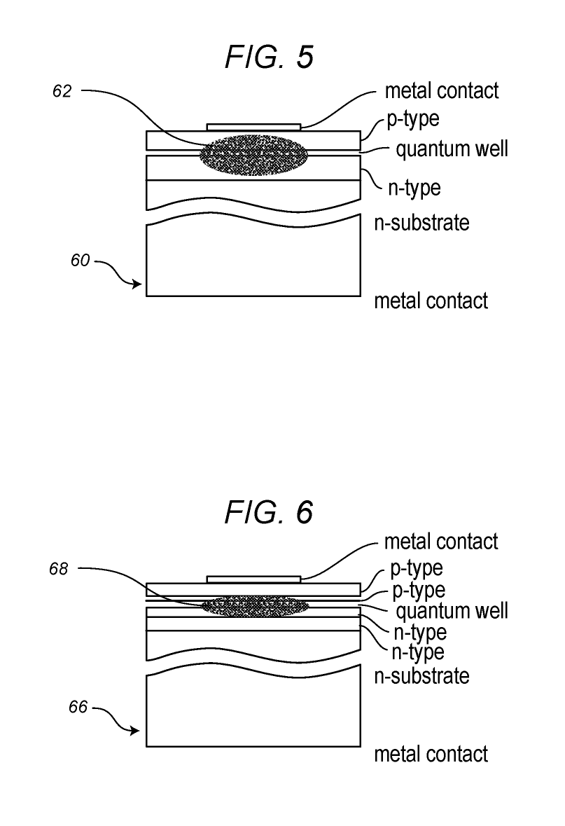

In a first stage, a signal is provided from the CCD 40 to the power supply 54 in order to bias the photodiode 60 (FIG. 5) comprising the laser 20, for example, and more specifically the quantum well 62 in the photodiode 60. An electron flow is provided at a sub-lasering level. The sub-lasering level is characterized as a pre-firing state. A low electron flow is provided. In a second stage, a software command is supplied to the CCD 40 to fire the laser 20 and a gate mode. The laser firing creates a weak diode effect. The emission from the laser 20 comprises a low level laser emission that is normally not visible. The omission, however, is detectable with a sensor such as the spectrograph 34.

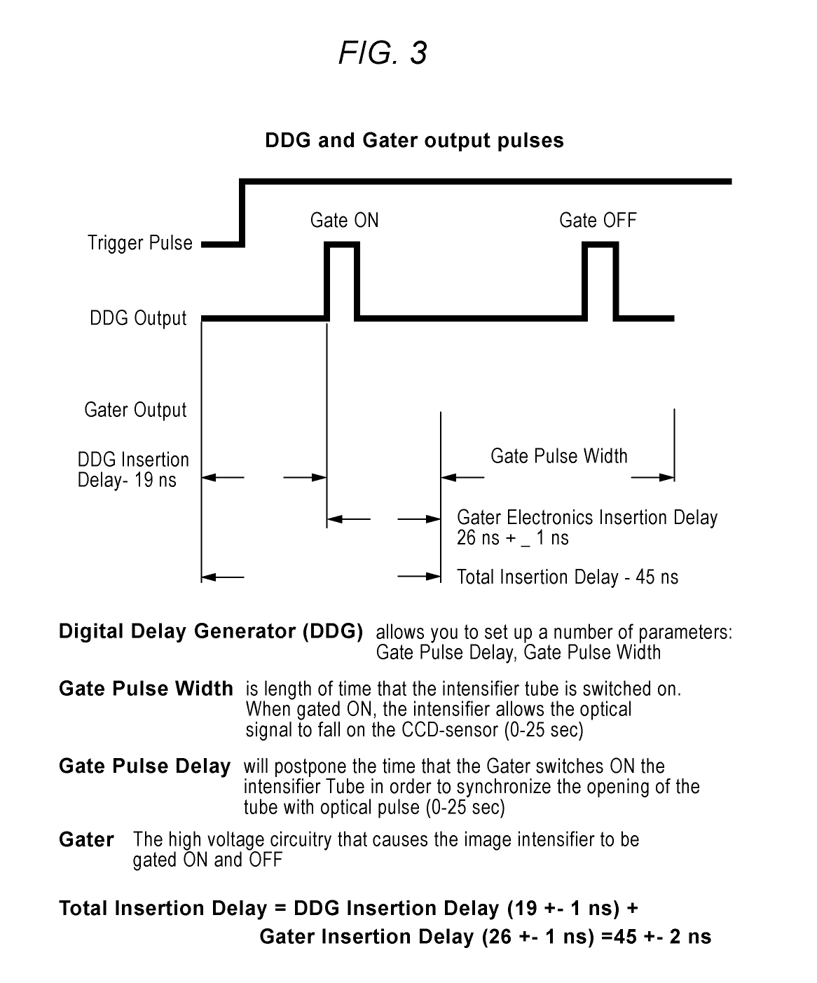

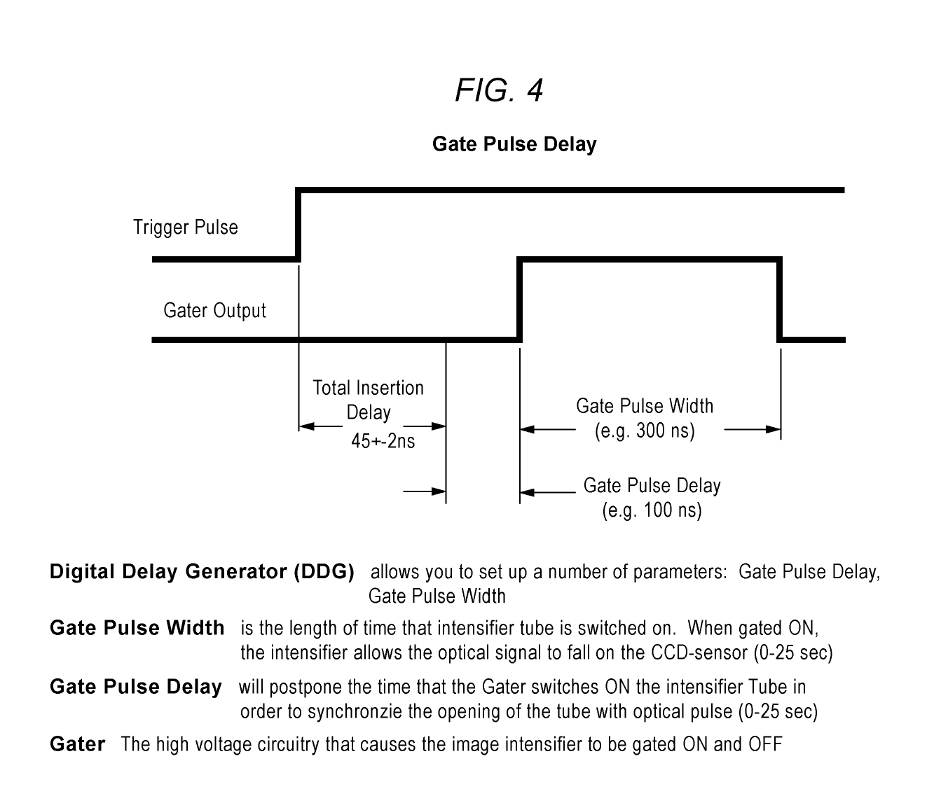

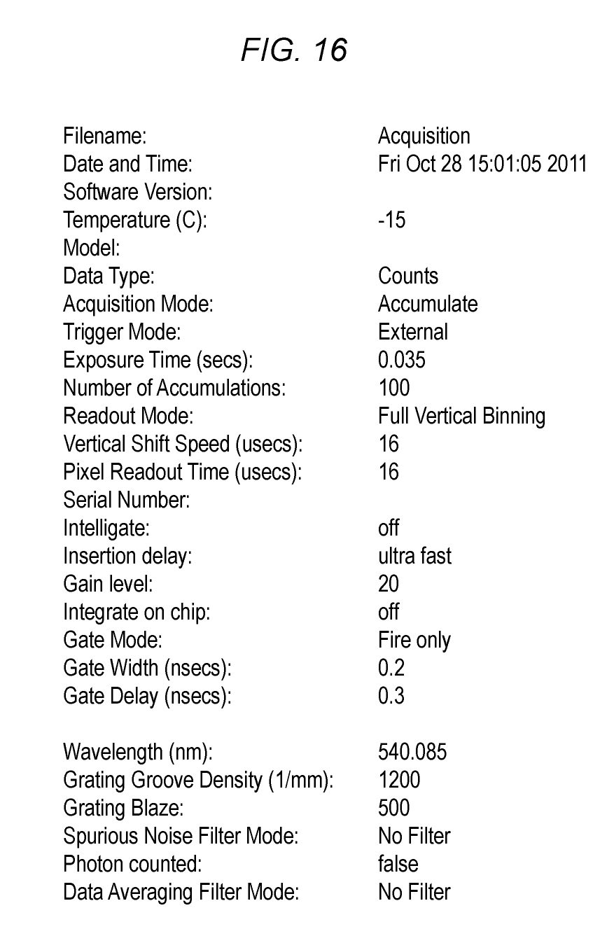

Operation of the LELS spectroscopy platform 10 is achieved, for example, through the following actions. Order of the steps may be changed where data generation and collection is not affected. In the present illustration, a sample of carbon fluorine, CF, is being analyzed. Reference numerals refer to components in FIG. 1.
a. Turn on electric power to the platform 10 to energize the power supply 54, Q-switched laser 20, spectrograph 34, photomultiplier 40, computer interface 44, and processor 50;
b. Allow warm-up time wait per manufacturers specifications for power supply 54 and Q-switched laser 20, e.g., 3 minutes;
c. Allow program and computer to show on the display 56 and control all components of platform 10;
d. Allow the CCD 40 to cool to −15° C. or colder;
e. Insert the sample 1, CF in the present illustration into the sample holder 2;
f. Set the Solis® (s) Software program to acquire spectral data as in the example discussed with respect to FIG. 15;
g. Set exposure time, accumulation frame rate, readout time, duration of acquisition as shown in FIG. 2;
h. Set the trigger pulse DDG output (gate on and off), gater output DDG insertion delay, and gate pulse width as shown in FIG. 3;
i. Set gate pulse delay digital delay generator to set up time parameters in nanoseconds for gate width and pulse delay as shown in FIG. 4;
j. Insert the settings as shown in FIG. 16, which have been used to produce the spectral data of CF sample seen in FIG. 15.
   Measurements on other forms of sample 1 are performed similarly.

In setting the external trigger signal parameters in the Solis® (s) Software program, first and second trigger signals are defined. In initiating operation, first, energy is provided from the power supply 54 to the quantum well of the diode laser 20 to bring the laser 20 to a pre-lasing state. Another increment of energy is provided from the power supply 54 to take the diode laser 20 to its lasing threshold. This causes the diode laser 20 to emit energy at an energy level lower than standard Raman spectroscopy levels.

The lasing threshold is the lowest excitation level at which a laser's output is dominated by stimulated emission rather than by spontaneous emission. Below the threshold, the laser's output power rises slowly with increasing excitation. Above threshold, the slope of power vs. excitation is orders of magnitude greater. The lasing threshold is reached when the optical gain of the laser medium is exactly balanced by the sum of all the losses experienced by light in one round trip of the laser's optical cavity.

The particles within the quantum well of the laser, which include omnipresent cosmological dark matter (OCDM) and omnipresent dark energy (OCDE) become quantum entangled with photons and any other particles existing in the quantum well of the laser creating a wave package.

FIGS. 2, 3, and 4 taken together illustrate the architecture of a non-transitory programmed medium to cause a processor to perform steps included in the present method. In FIGS. 2, 3, and 4, the abscissa is time and the ordinate represents ones and zeros of pulses. Operation may be viewed as beginning with a trigger pulse from the power supply 54. Hardware is illustrated in FIG. 1.

FIG. 2 is a chart illustrating operation of the platform to produce and receive signals, a method of providing performance. FIG. 2 illustrates accumulation of data. In FIG. 2, exposure time begins at time to. Exposure time is the time period in seconds during which received entities are allowed to fall on the CCD 40 prior to readout. Exposure time ends at time t₁. Readout occurs at time t₂. “Accumulate frame rate” is the number of frames of the CCD sensor accumulated per second. Duration of acquisition is the total length of time taken for an accumulated acquisition to occur to make up an entry to be stored in memory in the processor 50. The number of cycles in a “duration of acquisition” is preselected. The present example illustrates a duration of acquisition including cycles (1), (2), and (3).

FIG. 3 illustrates the timing and generation of gate pulses for the photomultiplier 40. A gating cycle begins at time t₁₀ from which digital delay is measured. The trigger pulse is the pulse supplied from the power supply 54 at time t₁₁. Time t₁₁ follows time t₁₀ by a preselected duration. A digital delay generator (DDG) signal permits setting of gate pulse delay and gate pulse width. Gate pulse width is the length of time for which the CCD 40 is switched ON. A DDG pulse extends from time t₁₂ to time t₁₃. The time span t₁₀-t₁₂ is the DDG insertion delay. After the insertion delay plus the gate pulse delay, the gate pulse width begins at time t₁₄ and ends at time t₁₅. When gated ON, the CCD 40 can sense inputs from the spectrograph 34. In a nominal embodiment, the gate pulse width is in the range of 0 to 25 seconds. The gate pulse delay postpones the time until the gater switches the CCD 40 ON in order to synchronize the opening of the CCD 40 with the optical pulse. The gater is the external trigger in the adjustable power supply 54. Total insertion delay in the present illustration equals the sum of the DDG insertion delay, i.e., 19 ns±1 ns, plus the gater insertion delay, i.e. 26 ns±1 ns, for a total of 45±2 ns.

FIG. 4 is a waveform chart illustrating relative timing of a trigger pulse and a gate pulse. The upper waveform is the trigger pulse and the lower waveform is the gater output. The digital delay generator allows setting parameters including gate pulse delay and gate pulse width. In the present illustration, the total insertion delay is 45±2 ns. The gate pulse delay is 100 ns. The gate pulse width is 300 ns.

FIG. 5 is a diagram of one form of quantum well laser diode 60 suitable for use in the laser 20 in the present platform 10. FIG. 5 illustrates a laser quantum well region 62 of quantum tunneling and weak diode effect, where secondary quantum tunneling and secondary wave package and entanglement occur. The present subject matter is not limited to a specific configuration.

FIG. 6 illustrates a further form of laser diode 66 comprising a separate confinement laser quantum well 68. The laser quantum well 68 also comprises a region of quantum tunneling and weak diode effect in laser quantum well 68, where secondary quantum tunneling and secondary wave package and entanglement occur.

FIG. 7 is a cross-sectional illustration of the Raman probe 26 which both excites and collects energy from a sample 1. Fiber optic coating and RF shielding connects the laser 20 (FIG. 1) energy transmission to and through optics of the Raman probe 26 through a focal lens 27 producing a convergence field 57 having a depth d for both excitation and collections of energies from the sample 1. A nominal depth d is 5 mm. The focal lens 27 redirects the energies from the excited sample 1 to a dichroic mirror 70 and a secondary mirror 72 to the second fiber optic strand 30.

FIG. 8 is a cross-sectional illustration of a single fiber optic strand 80 transmitting and receiving energy within the present system. A long length single strand fiber optic (LLFO) 82 is coated and shielded from ambient light and may exceed 18″ in length. The LLFO 82 comprises the fiber optic strand 80.

FIG. 9 is a cross-sectional illustration of a mechanical coupling 86 for stabilizing the LLFO 82. The LLFO 82 is inserted 2 mm into and through the coupling 86 to stabilize the LLFO 82 into the standard 5 mm convergence field 57 of the Raman probe 26.

FIG. 10 is a cross-sectional illustration of the mechanical coupling of LLFO 82 in axial alignment with the Raman probe 26. The depth of the convergence field 57 is extended by coupling a proximal end of the LLFO 82 into the convergence field 57 by 2 mm, thereby gaining a longer laser convergence field 57. The longer convergence field 57 irradiates and excites sample 1 and collects and returns emissions data through the same strand of LLFO 82 simultaneously. Extending the depth of the standard convergence 57 by inserting an LLFO 82 into the standard laser convergence field 57 provides a 600+% longer laser convergence field working range.

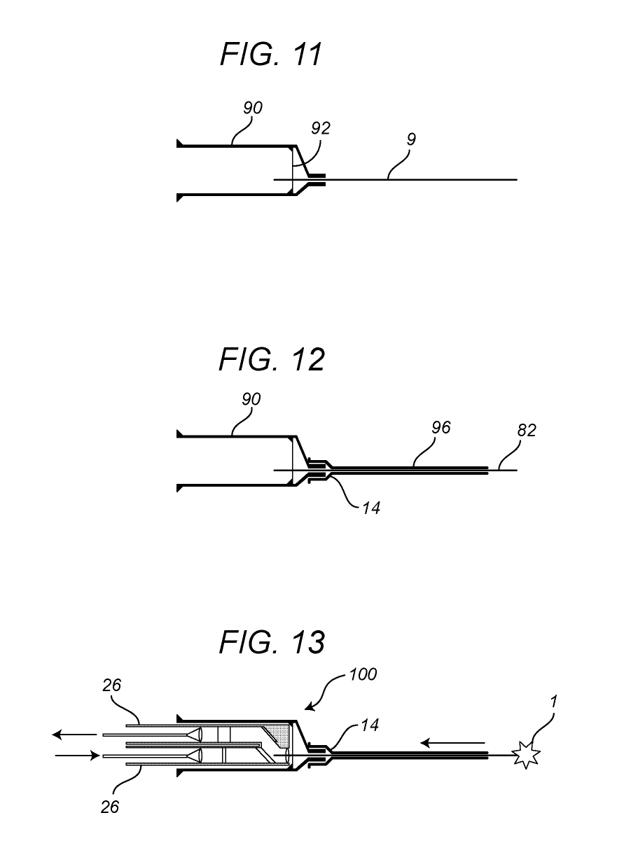

FIG. 11 is a cross-sectional illustration of the single fiber optic strand 80 of FIG. 8 inserted into a medical syringe 90. One length out of variable lengths of the LLFO 82 is inserted 2 mm through a neoprene alignment stop 92 located in the syringe 90 where an axial end of the Raman probe 26 will rest.

FIG. 12 is a cross-sectional illustration of a biopsy needle 96 having the LLFO 82 pre-inserted and being affixed to the syringe 90. The LLFO 82 and biopsy needle 96 form a module which may be conveniently attached to the syringe 90.

FIG. 13 is a cross-sectional illustration in which the Raman probe 26 is located in the syringe 90 to comprise a bioprobe 100. A one-time use sterile covering (not shown) is used over the bioprobe 100 for medical usage. The LLFO 82 projecting from the biopsy needle 96 is placed within 4 to 5 mm. of an in-vivo tissue sample 1 without intrusion into sample 1, which could be a tumor. The energies carried through LLFO 82 irradiate sample 1 and collect irradiated sample 1 energies back through the same single strand LLFO 82.

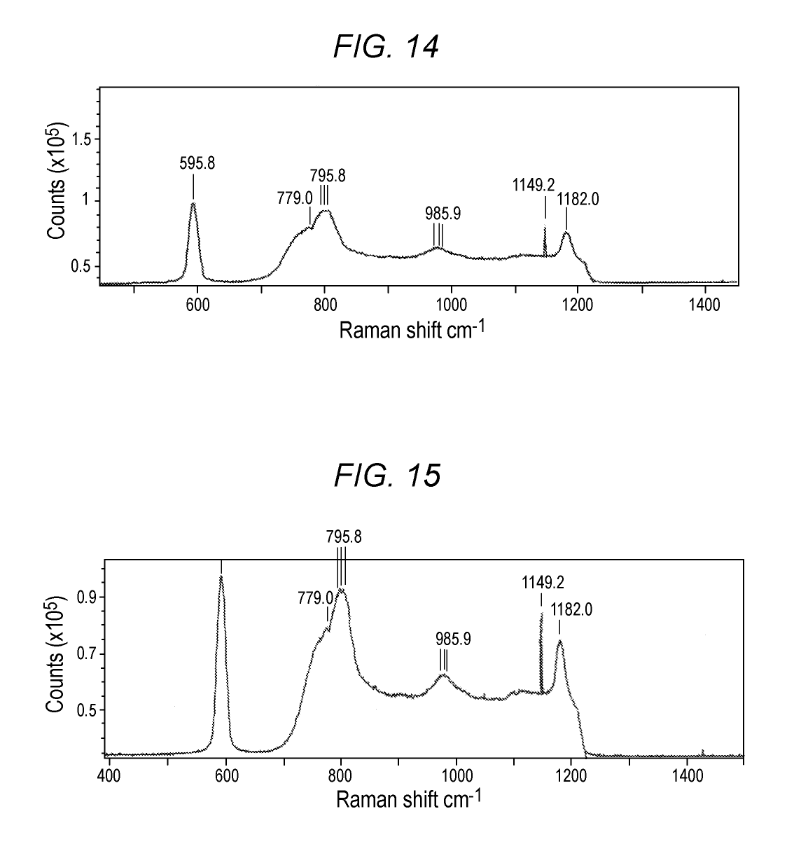

FIGS. 14 and 15 are each a plot of spectral data received by the Raman probe 26 from an irradiated sample 1 of carbon fluorine perfluorodecalin C10 F18. Perfluorodecalin C10 F18 is one of several formulations of synthetic blood. Various peaks are labeled by their respective wavelengths.

FIG. 14 is a plot of spectral data obtained by the Raman probe 26 according to FIG. 7 from an irradiated sample 1 of carbon fluorine perfluorodecalin chemical composition, which is a C10F18 biomarker.

Spectral data of FIG. 15 is received through the LLFO 82 by the Raman probe of FIG. 13. The spectral image in FIG. 15 shows increased sensitivity and higher peaks compared to data of the same sample 1 as seen in FIG. 14.

FIG. 16 is a printout of a nominal set of parameters referred to above with respect to operation of an LELS system running a spectroscopic analysis producing spectra of the type seen in FIG. 14 and FIG. 15. The settings are nominal for use of the And or Technologies apparatus described above in conjunction with FIG. 1. The Solis® (s) Software program will request a user to provide parameters such as via the GUI 58 (FIG. 1). A user gives a name to a file in which results from the spectrograph 34 and photomultiplier 40 have been processed by the processor 50 are stored. The entered acquisition mode “Accumulate” in the present illustration is used in connection with the operation according to FIG. 2. Other settings include parameter values for use in the operation illustrated by FIGS. 2, 3, and 4.

A photon count in the penultimate line of FIG. 16 reads “False.” On computer spectral runs, most of the photons will scatter on the surface or absorb into packaging material through sampling process.

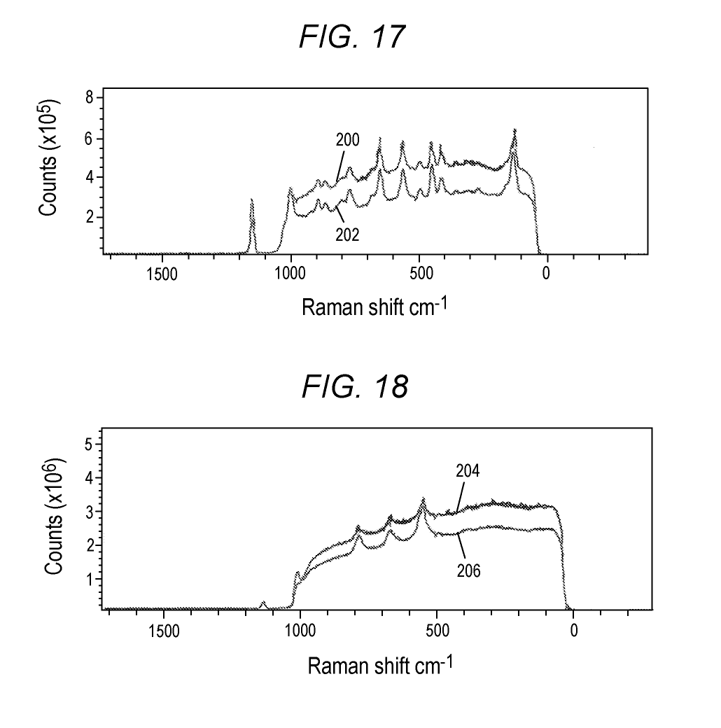

FIG. 17 comprises a spectrum plot 200 of Bayer® aspirin, C9H8O4, as irradiated through a blister pack container. Spectrum 202 is produced by the same tablet irradiated outside of the blister pack with photons still in entanglement. The spectrum 200 has a higher energy count than in spectrum 202. Photons scatter on and lose energy through absorption on solid surfaces. This increase in energy count through a solid object is atypical of all other Raman spectroscopy.

FIG. 18 comprises a spectrum 204 of Zyrtec® cetirizine irradiated through a blister pack. Spectrum 206 is for Zyrtec cetirizine® irradiated outside of the blister pack. The spectrum 204 has a higher energy count. This increase in energy count through a solid object is atypical of all other Raman spectroscopy and may be caused by energy-time entangled particles of OCDM-OCDE. In FIG. 18, spectrum 206 for Zyrtec pharmaceutical tablet irradiated outside of blister pack has a lower energy count.

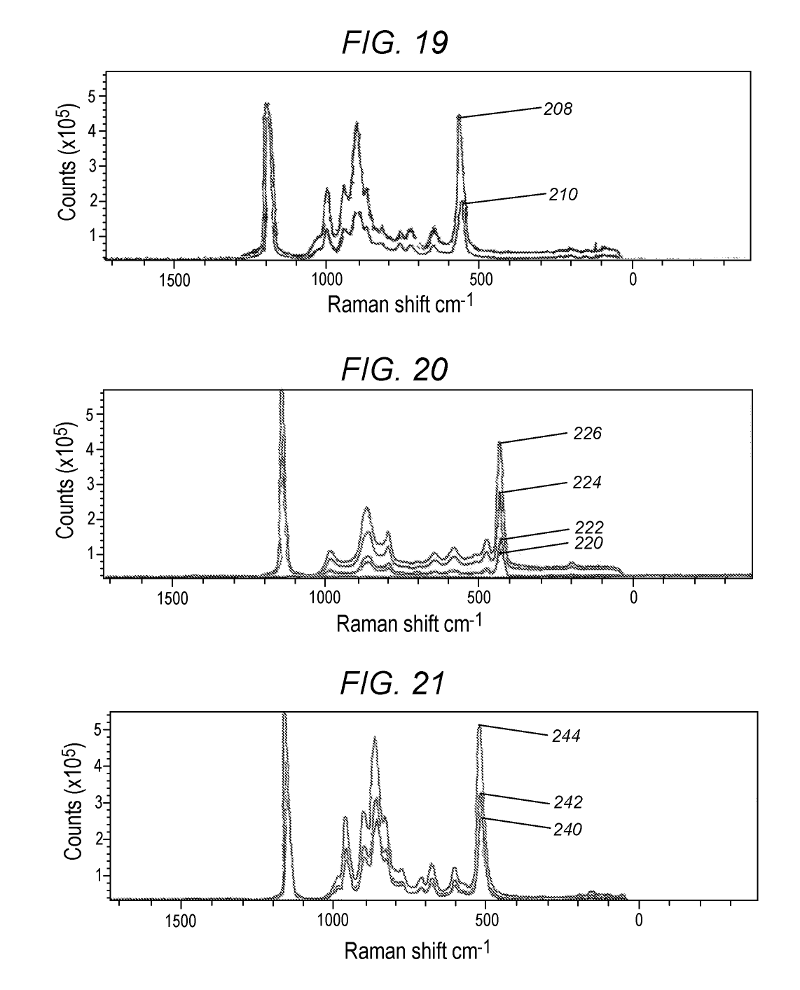

In FIG. 19 a spectrum 208 is generated from a static sample 1 of a carbon fluorine bond perfluorodecalin chemical composition. The sample 1 is not vibrated or stirred prior to irradiating and collecting spectral data as shown. In order to generate the spectrum 208, the sample 1 perfluorodecalin C10F18 is mixed, stirred, agitated in a test tube. Thirty seconds after agitating, the sample 1 is irradiated and the data is collected. The spectral results after sampling and collecting sample 1 data show an approximately 300% increase in energy count compared to the spectrum 210 of a static sample. The spectral count increases incrementally upon subsequent readings of the same spectral sample many minutes after initial excitation, evidencing continued propagation of energy. The LELS temporal delay effect has been observed and verified on spectral display from nanoseconds to many minutes long.

FIG. 20 illustrates actual spectra of sample 1 of carbon fluorine bond hexane chemical composition C6F14. The sample is irradiated and energies collected through LELS method. Spectra 220-226 are produced from a sample in the same test tube as follows:

220—static

222—vibrated, sampled after 30 seconds

224—vibrated, sampled after 5 minutes

226—vibrated, sampled after 20 minutes.

A notable energy count increase occurs after each successive time period.

FIG. 21 represents spectra of a carbon fluorine bond perfluorodecalin C10F18.

Spectra 230-234 are produced from a sample in the same test tube as follows;

230—static

232—vibrated, sampled after 30 seconds

234—vibrated, sampled after 5 minutes.

With respect to spectra 200 through 234, the spectral count on the imaging device, the photomultiplier 40 (FIG. 1), increases incrementally on subsequent readings of the spectra sample many minutes after initial excitation, evidencing continued propagation of energy and a time differential, a temporal delay. Evolving in free space, the time-dependent momentum and position space wave functions are:

$$Φ ( p , t ) = {( \frac{{x}_{0}}{ℏ \sqrt{π}} )}^{1 / 3} \cdot exp ( \frac{- {{x}_{0}^{2} ( p - {p}_{0} )}^{2}}{2 {ℏ}^{2}} - \frac{i {p}^{2} t}{2 m ℏ} ) , \\ Ψ ( x , t ) = {( \frac{1}{{x}_{0} \sqrt{π}} )}^{1 / 2} \cdot \frac{{e}^{- {z}_{0}^{2} {p}_{0}^{3} \sqrt{2} {ℏ}^{2}}}{\sqrt{1 + i {ω}_{0} t}} \cdot exp ( - \frac{{( x - i {x}_{0}^{2} {p}_{0} / ℏ )}^{2}}{2 {x}_{0}^{2} ( 1 + i {ω}_{0} t )} ) .$$

Since σₚ(t)=h/x₀\sqrt{2}, this can be interpreted as a particle moving along with constant momentum at arbitrarily high precision.

On the other hand, the standard deviation of the position is:

$${σ}_{z} ( t ) {σ}_{p} ( t ) = \frac{ℏ}{2} \sqrt{1 + {ω}_{0}^{2} {t}^{2}} .$$

such that the uncertainty product can only increase with time as:

$${σ}_{z} ( t ) {σ}_{p} ( t ) = \frac{ℏ}{2} \sqrt{1 + {ω}_{0}^{2} {t}^{2}} .$$

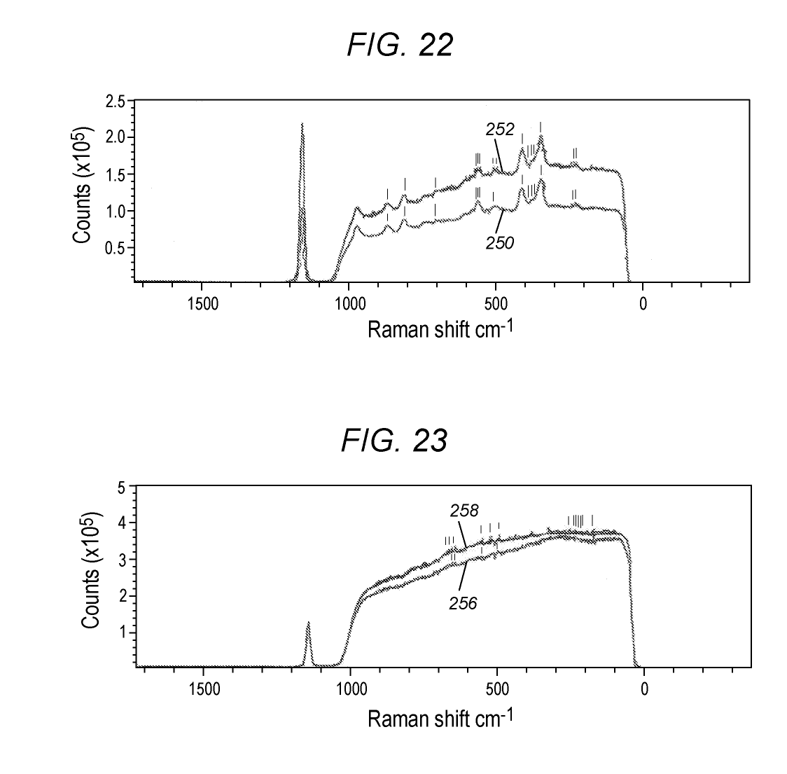

FIG. 22 represents actual spectra of energies collected from a sample of Tylenol® acetaminophen, C8H9N02. Spectrum 250 is obtained from a static sample. The spectrum 252 is produced from a vibrated sample and shows a notable increase in energies and spectral information.

FIG. 23 represents spectra 256 and 258 of Lipitor® atorvastatin, C33H35FN205 for static and vibrated samples respectively.

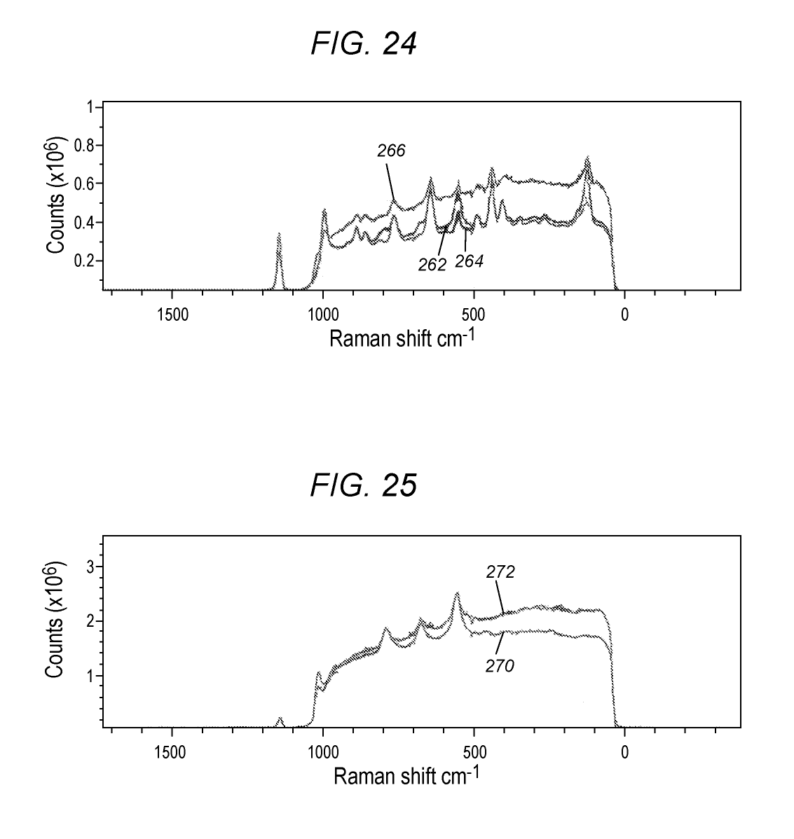

FIG. 24 illustrates spectra for three different forms of aspirin tablets. The tablets are irradiated separately by the same LELS method with no prior tablet preparation. Each sample is processed identically, irradiated, and the energies collected through the Raman probe 26 and sent on to computer analysis and spectral display.

The spectra correspond to each form of aspirin as follows:

262—counterfeit aspirin tablet brand #2

264—counterfeit aspirin tablet brand #1

266—Bayer® aspirin

A spectral comparison between the brand name aspirin tablet and two separate brands of generic or counterfeit aspirin tablets is provided. Spectrum 264 for generic tablet #1 differs markedly from brand name tablet spectrum 266 and slightly differs from generic tablet spectrum 262 for generic tablet #2. Spectrum 262 for counterfeit tablet #2 differs markedly from brand name tablet spectrum 266 and differs slightly from spectrum 264 produced from counterfeit tablet #1.

This demonstration of the sensitivity of the LELS method of detecting minute differences in percentage of chemicals in similar compounds may be used for many chemical compound analyses with real time results.

FIG. 25 illustrates comparison of a spectrum 270 generated from Lipitor® atorvastatin tablet and a spectrum 272 generated from a generic atorvastatin tablet. Both the solid brand name tablet and the solid counterfeit tablet are factory coated.

Each tablet was irradiated separately, by the same LELS method with no prior tablet preparation. Each sample is irradiated, and the energies collected through LELS method sent on to computer analysis and spectral display.

Spectrum 270 corresponding to Lipitor® atorvastatin brand has a higher percentage of the chemical compound of the pharmaceutical chemical signature C35H35FN205. Spectrum 272 corresponding to generic atorvastatin shows a lower percentage of the active ingredient C35H35FN205.

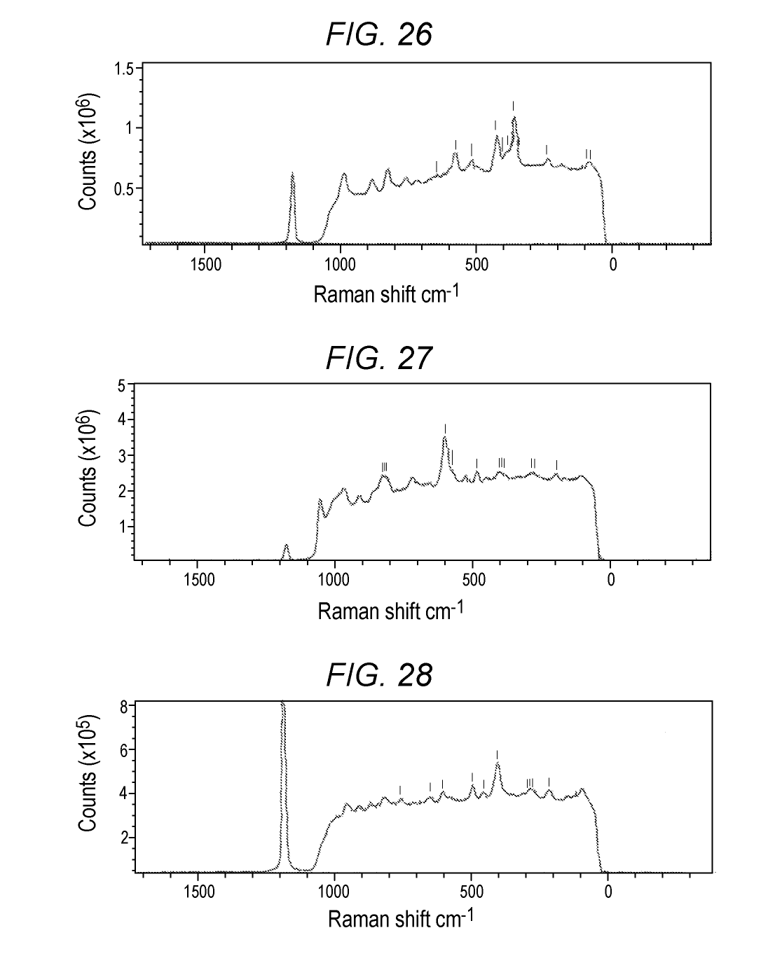

FIG. 26 represents a real time rapid assay and spectral results of pharmaceutical identification of Tylenol® acetaminophen, C8H9NO2. The spectrum of FIG. 26 is made with no prior preparation of Tylenol, with noiseless spectral results.

FIG. 27 represents a spectrum generated from Cipro® ciprofloxacin hydrochloride, C17H18FN3O3*HCl*H2O. The spectrum is generated from a solid tablet of Cipro ciprofloxacin hydrochloride made with no prior preparation, providing a clear spectrum.

FIG. 28 represents a spectrum generated from a solid tablet of Motrin® ibuprofen, C13H18O2, made with no prior preparation.

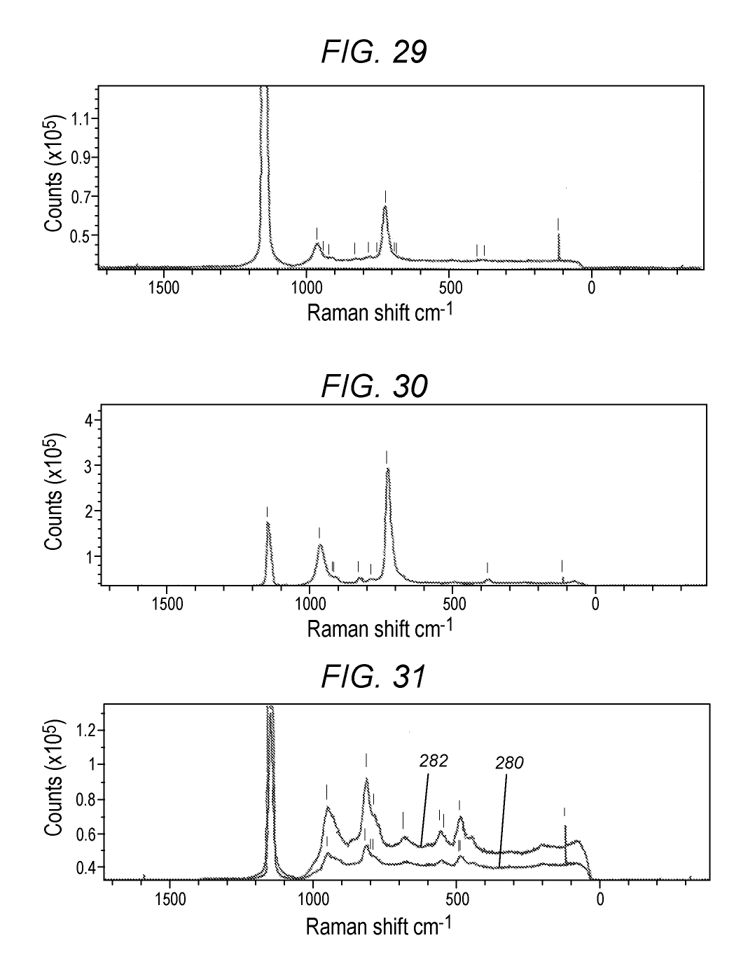

FIGS. 29 through 34 each represent the spectrum of a respective mineral or gemstone. Each sample is measured without prior preparation. The present LELS method of spectroscopy accomplishes same-time geological, metallurgical, and gemological assay and verification. The low energy device has reliably unique properties, extreme sensitivity, diversity, and functionality.

FIG. 29 represents a spectrum generated from amethyst crystal with natural dark purple coloring. Amethyst comprises SiO2 with minor Fe4+ impurities causing amethyst's color. The amethyst is of the class tectosilicate and has a hexagonal-R, 32(trigonal-trapezohedral) crystal system.

FIG. 30 represents a spectrum generated from quartz, a form of SiO2 of the class tectosilicate and having a hexagonal-R, 32(trigonal-trapezohedral) crystal system.

FIG. 31 represents spectra generated from tourmaline crystal. Elbaite is the most well-known individual member of the tourmaline group. Elbaite is the most transparent and colorful form of tourmaline. The term elbaite may be corrupted in the gemstone industry to refer specifically to green tourmaline. Spectrum 280 is generated from green elbaite, (Na,Ca)(Mg,Li,Al,Fe2+) 3Al6(BO3)3Si6O18(OH)4. Spectrum 282 is generated from rubellite, a pink to red variety of elbaite tourmaline.

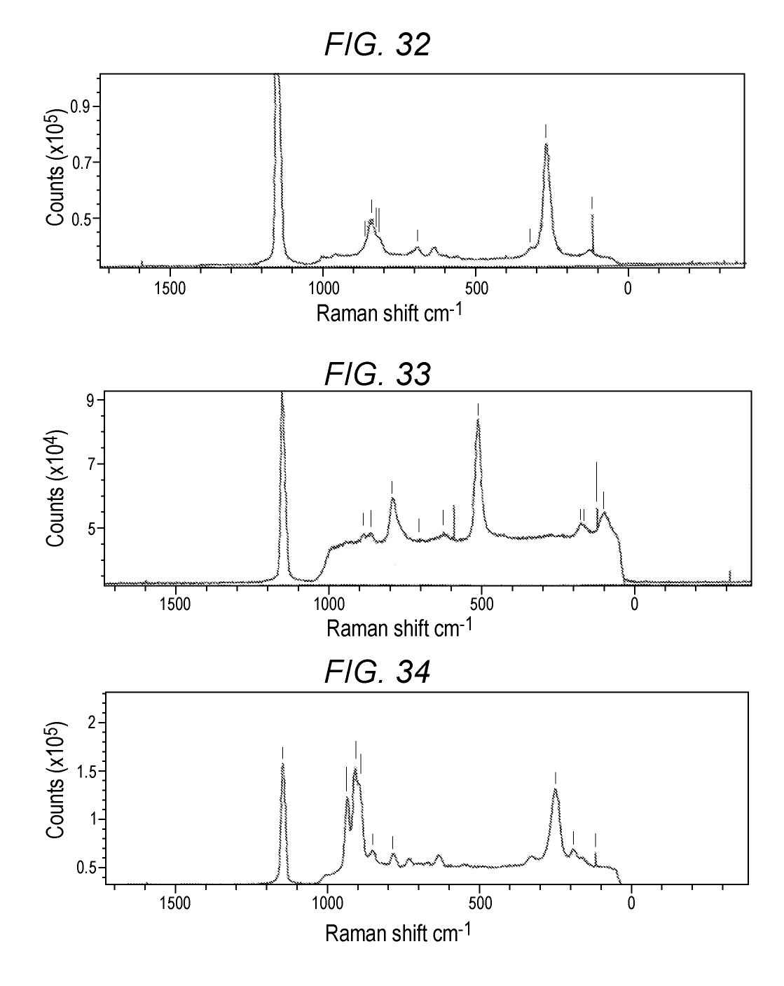

FIG. 32 represents a spectrum generated from an almandine garnet crystal, Fe3Al2(SiO4)3.

FIG. 33 represents a spectrum generated from clear morganite crystal, Be3Al2(SiO3)6.

FIG. 34 represents a spectrum generated from clear crystal topaz, (Al2SiO4(F,OH)2).

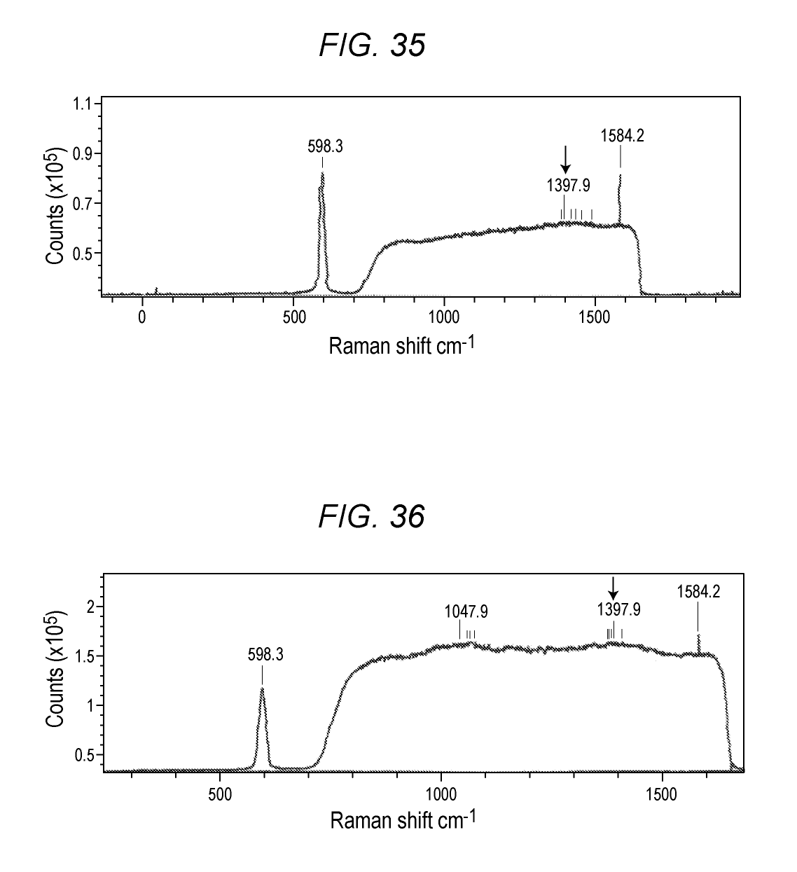

FIGS. 35 through 38 each represent a spectrum of a sample containing a noble metal.

FIG. 35 represents a spectrum generated from 0.925 sterling silver (Ag with a shiny surface).

FIG. 36 represents a spectrum generated from silver sulfate ointment (Ag 1% silver in solution).

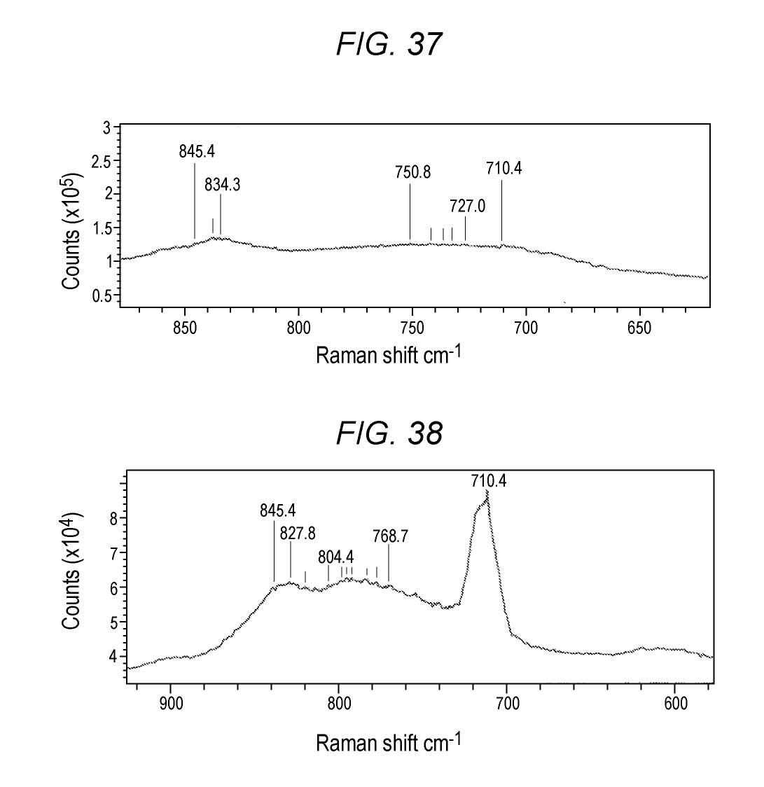

FIG. 37 represents a spectrum generated from 14 karat gold (58.65% gold AU at 710.4 nm on the spectrum).

FIG. 38 represents a spectrum generated from a typical rough ore sample from a tourmaline mine. The particular rough ore sample of FIG. 38 exhibits traces of silicates and gold at 710.4 nm on the LELS spectrum.

In some variations of the LELS method an extended single strand fiber optic probe which simultaneously emits and collects energies is used. The single strand longer length LELS probe method may be adapted for same-time multiple array sampling for pharmaceutical and many other scientific and commercial tests. LELS uses exclusive pre-tested bioorganic, biomedical, cellular and chemical tags and markers and reagents. The method of acquisition and the products of the method of acquisition of the quantum entangled states, fields, waves, wave packages, and energies as acquired by the LELS show a proven temporal delay in the spectroscopic display.

OCDM and OCDE may be acquired by many other means consistent with the disclosure herein, such as through laser emissions, diode emissions, quantum tunneling, acoustics, electronic pulse, oscillation, spectroscopy of all types, Raman spectroscopy, stokes, antistokes, scalar field, scalar wave, microscopy, optical generating, optical signals, optical pulses, semiconductor, super cooled semiconductors, manipulation of photons, manipulation of particles, material excited by excitation fields, superposition, super symmetry, signal beam, wave energies, wave packages, solar and magnetic activity, unknown particles and fields, unknown waves, wave packages, wave energies, harmonic frequencies, vibrational energies, holographic display, atmospheric audio and spectral display, atomic and sub atomic particles, supercooled atomic and subatomic particles, and particle duality states, for the acquisition or use of OCDM and OCDE.

What is claimed is:

1. A method for stimulating a sample to emit radiation comprising entities from which spectra may be generated, the method comprising:
providing a laser source for providing transmitted radiation for stimulating emission from the sample;
establishing a path for directing the transmitted radiation to the sample;
providing a first energy input to a quantum well of the laser to initiate a sublasing current flow;
providing a second energy to the input to induce a low level of lasing;
directing radiation from the laser to the sample;
receiving stimulated emission from the sample; and
directing the received stimulated emission for detection.

2. A method according to claim 1 wherein directing the transmitted radiation and directing the received stimulated emission comprises transmitting radiation along fiber-optic cable.

3. A method according to claim 2 wherein the step of directing transmitted radiation to the sample comprises transmitting the transmitted radiation through a focal lens and placing a sample at a focal point of the focal lens.

4. A method according to claim 3 further comprising detecting the received radiation using a detector capable of resolving entities included in the received radiation.

5. A method according to claim 4 wherein detecting the received radiation comprises utilizing a photomultiplier.

6. A method according to claim 5 comprising generating a spectrum for a sample from the received radiation sensed by the photomultiplier.

7. A method according to claim 6 wherein directing the transmitted radiation and directing the received stimulated emission comprises utilizing long length single strand fiber optic cable.

8. A method according to claim 7 wherein directing the transmitted radiation and directing the received stimulated emission comprises utilizing a Raman probe.

9. A method according to claim 5 wherein the laser comprises a Q-switched diode pump laser, the photomultiplier comprises a time-gated photomultiplier and further comprising the steps of providing a trigger pulse to initiate a laser output and a gate pulse having a gate pulse width defining a length of time for which the photomultiplier is switched ON, establishing a digital delay generator insertion delay between initiation of the trigger pulse and the gate pulse, the magnitude of the delay being selected to synchronize opening of the photomultiplier with received radiation.

10. A method according to claim 9 further comprising utilizing laser excitation having a wavelength of 532 nm.

11. A spectroscopy platform comprising a Q-switched diode pumped laser, a time-gated photomultiplier and a timing circuit comprising a triggering circuit providing a trigger pulse to initiate a laser output and providing a gate pulse having a gate pulse width defining a length of time for which the photomultiplier is switched ON, a digital delay generator creating an insertion delay between initiation of the trigger pulse and the gate pulse, the magnitude of the delay being selected to synchronize opening of the photomultiplier with received radiation.

12. A spectroscopy platform according to claim 11 wherein the timing circuit comprises circuitry for setting parameters including gate pulse delay and gate pulse width.

13. A spectroscopy platform according to claim 12 wherein the laser comprises a laser diode having a quantum well and a power supply coupled to provide a first current to said quantum well to induce a sublasing state and providing a triggering pulse to induce lasing.

14. A spectroscopy platform according to claim 12 wherein said laser diode comprises a separate confinement laser quantum well comprising a region of quantum tunneling and weak diode effect.

15. A spectroscopy platform according to claim 12 wherein said timing circuit is set to provide an exposure time wherein the photomultiplier is in an ON state, said timing circuit setting a duration of an acquisition for accumulating data from said photomultiplier comprising a preselected number of exposure times.

16. A spectroscopy platform according to claim 15 wherein said laser provides radiation in the green spectrum.

17. A spectroscopy platform according to claim 16 further comprising a Raman probe coupling transmitted energy to the sample and coupling received energy to the photomultiplier.

18. A non-transitory machine-readable medium which when executed on a processor provides instructions to:
provide a trigger pulse to initiate a laser output and a gate pulse having a gate pulse width defining a length of time for which a photomultiplier is switched ON, establishing a digital insertion delay between initiation of the trigger pulse and the gate pulse, the magnitude of the delay being selected to synchronize opening of the photomultiplier with received radiation;
establish a duration of an acquisition during which outputs of said photomultiplier are accumulated; and
generate a spectrum based on measurement of entities received by the photomultiplier.

19. A non-transitory machine-readable medium according to claim 18 further causing the processor to set parameters including gate pulse delay and gate pulse width.

20. A non-transitory machine-readable medium according to claim 19 further causing the processor to provide a digital delay generator time delay plus a gater insertion delay between initiation of the trigger pulse and the gate pulse.
